(19) United States
(12) Patent Application Publication
(10) Pub. No.: US 2017/0300889 A1
(43) Pub. Date: Oct. 19, 2017

(54) INFORMATION PROVISION SYSTEM AND INFORMATION PROVISION METHOD

(71) Applicant: TOSHIBA TEC KABUSHIKI KAISHA, Tokyo (JP)

(72) Inventors: Naoki Watanabe, Adachi Tokyo (JP); Tomonori Ikumi, Numazu Shizuoka (JP); Masami Takahata, Setagaya Tokyo (JP)

(21) Appl. No.: 15/459,074

(22) Filed: Mar. 15, 2017

(30) Foreign Application Priority Data
Apr. 13, 2016 (JP) 2016-080315

(51) Int. Cl. G06Q 20/20; G07G 5/00; G07G 1/00

(52) U.S. Cl. CPC G06Q 20/209; G07G 1/0045; G07G 5/00

(57) ABSTRACT

According to one embodiment, After a payment is completed, the notification unit notifies transaction information and a transaction code. The issuing unit issues a voucher on which a visible code representing the transaction code is printed. The creation unit creates provision information based on the notified transaction information. The created provision information is stored in the storage unit in a state of being associated with the transaction code. The reading unit optically reads the visible code that is printed on the voucher. The request unit makes a request for information provision, which is accompanied by the notification of the transaction code that is represented by the visible code. The transaction unit transmits the provision information that is stored in the state of being associated with the transmission code that is notified. The output unit outputs the provision information that is transmitted.

### CROSS-REFERENCE TO RELATED APPLICATION

This application is based upon and claims the benefit of priority from Japanese Patent Application No. 2016-80315, filed Apr. 13, 2016, the entire contents of which are incorporated herein by reference.

### FIELD

Embodiments described herein relate generally to an information provision system and an information provision method.

### BACKGROUND

In some cases, pieces of additional information other than information relating to contents of commercial transaction, such as various guides and advertisements, are printed on a receipt that is issued after a payment for the commercial transaction is completed. However, when the time that it takes to issue the receipt is lengthened, because there is a concern that an accounting corner or the like of a store will be crowded, there are many limits on selection of information that is used as the additional information.

With an electronic receipt system, when a customer checks a receipt later on, arbitrary information can be additionally informed. However, in the electronic receipt system, because on the system side, there is a need to recognize which of the customers each commercial transaction relates to, it is indispensable to register a user of a service in advance. Furthermore, the customer needs to need a membership card, or the like and to input an identification code of the user of the service into a payment terminal. More precisely, in the electronic receipt system, no information can be provided to a customer who is not registered as a member.

From this situation, it is desirable that information that is accordingly suitable for an unspecified customer can be provided to the unspecific customer in a somewhat limited manner.

### DESCRIPTION OF THE DRAWINGS

FIG. 1 is a block diagram illustrating a schematic configuration of an information provision system according to an embodiment, and an essential circuit configuration of each of the apparatuses that constitute the information provision system.

FIG. 2 is a flowchart of controlling by a processor that is included in a POS terminal in FIG. 1.

FIG. 3 is a flowchart of controlling by a processor that is included in a provision server in FIG. 1.

FIG. 4 is a flowchart of controlling by a processor that is included in an information terminal in FIG. 1.

### DETAILED DESCRIPTION

An object of an exemplary embodiment is to provide an information provision system and an information provision method, which are capable of providing information, which is accordingly suitable for an unspecified customer, to the unspecific customer in a somewhat limited manner.

In general, according to one embodiment, there is provided an information provision system including a payment terminal, an information provision apparatus, and an information terminal. The payment terminal includes a payment unit, a notification unit, and an is suing unit. The information provision apparatus includes a creation unit, a storage unit, and a transmission unit. The information terminal includes a reading unit, a request unit, and an output unit. The payment unit makes a payment of a price relating to a commercial transaction. The notification unit notifies the information provision apparatus of transaction information indicating contents of the commercial transaction, and a transaction code for identifying the commercial transaction, after the payment is completed. The issuing unit issues a voucher on which a visible code representing the transaction code in an optically readable manner is printed. Based on the notified transaction information, the creation unit creates provision information that is provided to a person who makes a payment for the commercial transaction relating to the transaction information. The created provision information is stored in the storage unit, in a state of being associated with the transaction code that is notified along with the transaction information, based on which the provision information is created. The reading unit optically reads the visible code that is printed on the voucher. The request unit makes a request to the information provision apparatus for information provision, which is accompanied by the notification of the transaction code that is represented by the visible code which is read. The transmission unit transmits to the information terminal the provision information that is stored in the state of being associated with the transaction code that is notified, when the request is made. The output unit outputs the provision information that is transmitted, in such a manner that the provision information is recognizable to an operator of the information terminal.

An embodiment will be described below with reference to the drawings. Moreover, according to the embodiment, as an example, an information provision system that provides information to a shopper in a store where a commodity is sold. That is, a commercial transaction according to the embodiment, is a commodity sale.

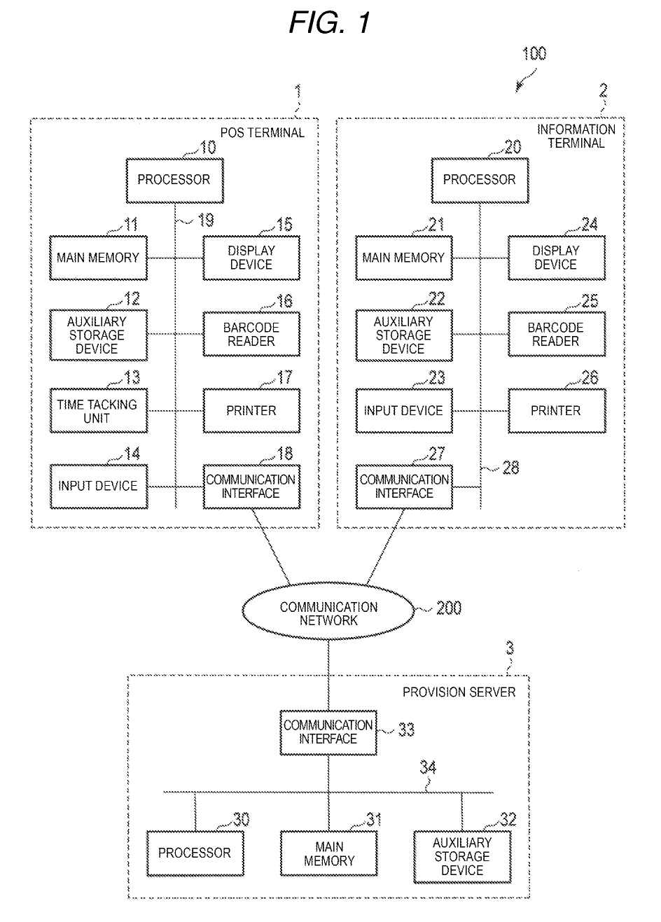

FIG. 1 is a block diagram illustrating a schematic configuration of an information provision system 100 according to the embodiment, and an essential circuit configuration of each of the apparatuses that constitute the information provision system 100.

The information provision system 100 includes a point-of-sale (POS) terminal 1, an information terminal 2, and a provision server 3. The information provision system 100 has such a configuration that the POS terminal 1 and the information terminal 2 are capable of communicating with the provision server 3 through a communication network 200. The communication network 200 includes, for example, a local area network (LAN) and the Internet. However, as the communication network 200, various networks, such as a LAN, the Internet, and a mobile communication network, may be used singly or be arbitrarily in combination with each other.

### Description of the POS Terminal 1

The POS terminal 1 is installed beside a check-out counter of the store, and is operated by a salesperson that plays the role of a cashier. The POS terminal 1 performs various types of processing for sale data processing in connection with a commodity sale, such as registration, accounting, and issuing. The processing will be described individually in detail below.

The POS terminal 1 includes a processor 10, a main memory 11, an auxiliary storage device 12, a time tracking unit 13, an input device 14, a display device 15, a barcode reader 16, a printer 17, a communication interface 18, and a system transfer path 19. The processor 10, the main memory 11, the auxiliary storage device 12, the time tracking unit 13, the input device 14, the display device 15, the barcode reader 16, the printer 17, and the communication interface 18 are connected to one another through the system transfer path 19 that includes an address bus, a data bus, and a control signal line, and the like. Moreover, as the hardware of the POS terminal 1, the hardware of a ready-made POS terminal, as is, can be used.

In the POS terminal 1, a connection of the processor 10, the main memory 11, and the auxiliary storage device 12 to one another through the system transfer path 19 constitutes a computer that controls the POS terminal 1.

The processor 10 is equivalent to a central portion of the computer described above. The processor 10 controls each of the units in order to realize various functions for the POS terminal 1, according to an operating system or an application program.

The main memory 11 is a main memory portion of the computer described above. The main memory 11 includes a nonvolatile memory area and a volatile memory area. The operating system and the application program are stored in the nonvolatile memory of the main memory 11. Furthermore, there is also a case where data necessary for the processor 10 to control each of the units is stored in the nonvolatile or volatile memory area of the main memory 11. The volatile memory area of the main memory 11 is used as a working area where data is suitably rewritten by the processor 10. The volatile memory area includes an area where a list of the purchase commodity described above is stored, that is, a so-called registering area.

The auxiliary storage device 12 is equivalent to an auxiliary storage portion of the computer described above. The auxiliary storage devices 12, for example, include an electric erasable programmable read-only memory (EEPROM), a hard disc drive (HDD), a solid state drive (SSD), and the like. The auxiliary storage device 12 retains data that is used by the processor 10 to perform various types of processing, or data that is generated by the processing by the processor 10. The application program is stored in the auxiliary storage device 12.

Application programs, which are stored in the main memory 11 or the auxiliary storage device 12, include a control program that is described for controlling by the processor 10, which will be described. Generally, the POS terminal 1 is handed over in a state where the control program is stored in the main memory 11 or the auxiliary storage device 12. However, there is also a case where the POS terminal 1 is handed over in a state where the control program is not stored in the main memory 11 or the auxiliary storage device 12. In this case, the control program is handed over in a state of being stored on a removable recording medium, such as a magnetic disk, a magnetic optical disk, an optical disk, or a semiconductor memory. Alternatively, the control program is handed over through a network. Then, the control program may be written to the main memory 11 or the auxiliary storage device 12 of the POS terminal 1 that is separately handed over, which is described above.

The time tracking unit 13 always performs a time tracking operation, and outputs date and time information indicating a current date and point in time.

The input device 14 receives input data from an operator, and outputs input information in response to the input data. As the input device 14, for example, a keyboard, a mouse, a touch panel, or the like can be used.

An image showing various pieces of information that have to be provided to the operator is displayed on the display device 15. As the display device 15, for example, a liquid crystal display (LCD), a touch panel, or the like can be used.

The barcode reader 16 reads a barcode that is shown on an employee ID card or a name plate that is carried by a salesperson, and that indicates a salesperson code for identifying the salesperson. The barcode reader 16 may be used interchangeably with a device for reading a barcode that is shown on a commodity, and that indicates a commodity code for identifying the commodity. For that reason, the device may be provided separately from the barcode reader 16.

The printer 17 prints various strings of characters and various images on a sheet of receipt paper. Then, the printer 17 issues a receipt by ejecting the sheet of receipt paper, which is printing-completed, to the outside of the POS terminal 1. As the printer 17, for example, a thermal printer or a dot impact printer can be used.

The communication interface 18 performs data communication through the communication network 200.

### Description of the Information Terminal 2

The information terminal 2 is installed as a so-called kiosk terminal in the store. The information terminal 2 is operated by a shopper, and outputs information that has to be provided by the information provision system 100, in such a manner that the shopper is able to recognize the information.

The information terminal 2 includes a processor 20, a main memory 21, an auxiliary storage device 22, an input device 23, a display device 24, a barcode reader 25, a printer 26, a communication interface 27, and a system transfer path 28. The processor 20, the main memory 21, the auxiliary storage device 22, the input device 23, the display device 24, the barcode reader 25, the printer 26, and the communication interface 27 are connected to one another through the system transfer path 28 that includes an address bus, a data bus, and a control signal line, and the like. Moreover, as the hardware of the information terminal 2, the hardware of a ready-made kiosk terminal, as is, can be used.

In the information terminal 2, a connection of the processor 20, the main memory 21, and the auxiliary storage device 22 to one another through the system transfer path 28 constitutes a computer that controls the information terminal 2.

The processor 20 is equivalent to a central portion of the computer described above. The processor 20 controls each of the units in order to realize various functions for the information terminal 2, according to an operating system or an application program.

The main memory 21 is a main memory portion of the computer described above. The main memory 21 includes a nonvolatile memory area and a volatile memory area. The operating system and the application program are stored in the nonvolatile memory area of the main memory 21. Furthermore, there is also a case where data necessary for the processor 20 to control each of the units is stored in the nonvolatile or volatile memory area of the main memory 21. The volatile memory area of the main memory 21 is used as a working area where data is suitably rewritten by the processor 20.

The auxiliary storage device 22 is equivalent to an auxiliary storage portion of the computer described above. The auxiliary storage devices 22, for example, include an EEPROM, an HDD, an SSD, and the like. The auxiliary storage device 22 retains data that is used by the processor 20 to perform various types of processing, or data that is generated by the processing by the processor 20. The application program is stored in the auxiliary storage device 22.

Application programs, which are stored in the main memory 21 or the auxiliary storage device 22, include a control program that is described for controlling by the processor 20, which will be described. Generally, the information terminal 2 is handed over in a state where the control program is stored in the main memory 21 or the auxiliary storage device 22. However, there is also a case where the information terminal 2 is handed over in a state where the control program is not stored in the main memory 21 or the auxiliary storage device 22. In this case, the control program is handed over in a state of being stored on a removable recording medium, such as a magnetic disk, a magnetic optical disk, an optical disk, or a semiconductor memory. Alternatively, the control program is handed over through a network. Then, the control program may be written to the main memory 21 or the auxiliary storage device 22 of the information terminal 2 that is separately handed over, which is described above.

The input device 23 receives input data from an operator, and outputs input information in response to the input data. As the input device 23, for example, a keyboard, a mouse, a touch panel, or the like can be used.

An image showing various pieces of information that have to be provided to the operator is displayed on the display device 24. As the display device 24, for example, a liquid crystal display (LCD), a touch panel, or the like can be used.

The barcode reader 25 reads a barcode that is printed on a receipt, as will be described below.

The printer 26 prints various strings of characters and various images on a sheet of printing paper. Then, the printer ejects the sheet of printing paper, which is printing-completed, to the outside of the information terminal 2. As the printer 26, for example, a thermal printer, a dot impact printer, an inkjet printer, an electronic photographic printer, or the like can be used.

The communication interface 27 performs the data communication through the communication network 200.

### Description of the Provision Server 3

The provision server 3 creates provision information that has to be provided to the shopper in response to a request from the POS terminal 1, and retains and manages the provision information. The provision server 3 gives to the information terminal 2 a printing file for printing a suitable one among pieces of provision information that are retained, in response to a request from the information terminal 2. As such, the provision server 3 is one example of an information provision apparatus.

The provision server 3 includes a processor 30, a main memory 31, an auxiliary storage device 32, a communication interface 33, and a system transfer path 34. The processor 30, the main memory 31, the auxiliary storage device 32, and the communication interface 33 are connected to one another through the system transfer path 34 that includes an address bus, a data bus, a control signal line, and the like. Moreover, as the hardware of the provision server 3, the hardware of a ready-made computer, as is, can be used.

In the provision server 3, a connection of the processor 30, the main memory 31, and the auxiliary storage device 32 with one another through the system transfer path 34 constitutes a computer that controls the provision server 3.

The processor 30 is equivalent to a central portion of the computer described above. The processor 30 controls each of the units in order to realize various functions for the provision server 3, according to an operating system or an application program.

The main memory 31 is a main memory portion of the computer described above. The main memory 31 includes a nonvolatile memory area and a volatile memory area. The operating system and the application program are stored in the nonvolatile memory area of the main memory 31. Furthermore, there is also a case where data necessary for the processor 30 to control each of the units is stored in the nonvolatile or volatile memory area of the main memory 31. The volatile memory area of the main memory 31 is used as a working area where data is suitably rewritten by the processor 30.

The auxiliary storage device 32 is equivalent to an auxiliary storage portion of the computer described above. The auxiliary storage devices 32, for example, include an EEPROM, an HDD, an SSD, and the like. The auxiliary storage device 32 retains data that is used by the processor 30 to perform various types of processing, or data that is generated by the processing by the processor 30. The application program is stored in the auxiliary storage device 32.

Application programs, which are stored in the main memory 31 or the auxiliary storage device 32, include a control program that is described for controlling by the processor 30, which will be described. Generally, the provision server 3 is handed over in a state where the control program is stored in the main memory 31 or the auxiliary storage device 32. However, there is also a case where the provision server 3 is handed over in a state where the control program is not stored in the main memory 31 or the auxiliary storage device 32. In this case, the control program is handed over in a state of being stored on a removable recording medium, such as a magnetic disk, a magnetic optical disk, an optical disk, or a semiconductor memory. Alternatively, the control program is handed over through a network. Then, the control program may be written to the main memory 31 or the auxiliary storage device 32 of the provision server 3 that is separately handed over, which is described above.

The communication interface 33 performs the data communication through the communication network 200.

### Description of Operation of the Information Provision System 100

Next, operation of the information provision system 100 that is configured as described above is described. Moreover, details of various types of processing for realizing the operation that will be described below is one example, and various types of processing capable of providing the same result can arbitrary employed.

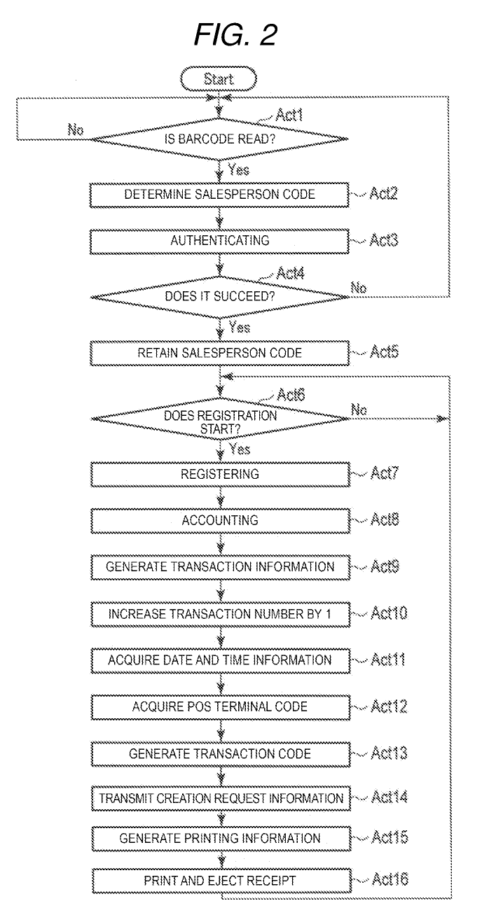

When the POS terminal 1 is activated in a normal operation mode, the processor 10 starts the controlling that is based on the control program which is stored in the main memory 11 or the auxiliary storage device 12. FIG. 2 is a flowchart of controlling by the processor 10.

In Act 1, the processor 10 checks whether or not a barcode is read by the barcode reader 16. Then, if the barcode is not read, the processor 10 repeats Act 1. As such, the processor 10 waits for the barcode to be read in Act 1.

A salesperson who is in charge of operating the POS terminal 1 causes a barcode, which is shown on the employee ID card, the name plate, or the like that is carried by him/her, to be read by the barcode reader 16. Thus, the barcode reader 16 optically reads the barcode, and outputs barcode information that is indicated by the barcode. In response to this, the processor 10 determines in Act 1 that a result is Yes, and proceeds to Act 2.

In Act 2, the processor 10 decodes barcode data that is output from the barcode reader 16 as described above, and, by extracting a salesperson code that is shown in the decoded data, determines the salesperson code for identifying the salesperson who is in charge of operating the POS terminal 1.

In Act 3, the processor 10 performs authenticating based on the determined salesperson code, which is described above. One example of this authenticating is performed as follows.

The processor 10 transmits the salesperson code described above to a management server that is connected to the communication network 200, which is not illustrated. The salesperson code of the salesperson who operates the POS terminal 1, and salesperson information relating to the salesperson, for example, such as a full name, are stored in a code management area of a storage device that is included in the management server, in a state of being associated with each other. The management server conducts a search to check whether or not the salesperson code that is transmitted as described above is present in the code management area, and replies to the POS terminal 1 with response information that contains a detail in accordance with a result of conducting the search. The response information if the salesperson code is present indicates that the salesperson code is present, and includes the salesperson information that is stored in the code management area, in a state of being associated with the salesperson code. The response information if the salesperson code is not present indicates that the salesperson code is not present. The processor 10 acquires the response information with which the management server replies, through the communication interface 18.

In Act 4, the processor 10 checks whether or not authentication succeeds. If the authenticating is performed as in the example describe above, if the response information indicates that the salesperson code is present, the processor 10 determines that the authentication succeeds, and, if not, determines that the authentication fails. If it is determined that the authentication fails, the processor 10 returns to Act 1. At this time, the processor 10 may cause a screen for alerting an operator that the authentication fails, to be displayed on the display device 15. Then, if it is determined that the authentication succeeds, the processor 10 proceeds from Act 4 to Act 5.

In Act 5, the processor 10 confirms the salesperson code that is determined in Act 2, as that of the operator, and retains the confirmed salesperson code in the main memory 11 or the auxiliary storage device 12. Moreover, on this occasion, based on the salesperson information that is included in the response information, one portion of information on the operator, such as a full name, may be displayed on the display device 15.

In Act 6, the processor 10 checks whether or not registration of a purchase commodity that is a new transaction target is started. Then, if an operation for the registration of the purchase commodity is not performed, the processor 10 determines that a result is No, and repeats Act 6. As such, in Act 6, the processor 10 waits for the registration of the purchase commodity to be started. Then, if the operation for the registration of the purchase commodity is performed, the processor 10 determines in Act 6 that a result is Yes, and proceeds to Act 7.

In Act 7, the processor 10 performs registering. The registering is processing that adds a commodity that is purchased by a shopper, to a purchase commodity list. As the registering, the same processing as is performed in the ready-made POS terminal can be used.

In Act 8, the processor 10 performs accounting. The accounting includes calculating and paying. The calculating is processing that calculates prices of commodities that are included in the purchase communication list. The paying is processing that makes a payment of the prices. As the accounting, the same processing as is performed in the ready-made POS terminal can be used. As such, the performance by the processor 10 of the controlling based on the control program enables the computer of which the central portion is the processor 10 to function as a payment unit. Then, the POS terminal 1 functions as a payment terminal. Furthermore, the shopper is a person who makes a payment.

In Act 9, the processor 10 generates transaction information. The processor 10 includes all portions of, or one or several of pieces of information that are shown in the purchase commodity list, for example, pieces of information relating to results of the payment, such as a payment amount, a deposit amount, and a change amount, in the transaction information.

In Act 10, the processor 10 increases a transaction number by 1. The transaction number is a serial number of the transaction that is processed in the POS terminal 1.

In Act 11, the processor 10 acquires the date and time information that is output by the time tracking unit 13. A date and time that is indicated by the date and time information is equivalent to a date and time when the payment is completed.

In Act 12, the processor 10 acquires a POS terminal code. The POS terminal code is a code that is allocated in advance to the POS terminal 1. If a plurality of POS terminals 1 are installed in the store, the POS terminal codes are allocated to the plurality of POS terminals 1, respectively, in such a manner that the plurality of POS terminals 1 are capable of being identified. When a job of installing the POS terminal 1 or a job of maintenance is performed, the POS terminal code is retained in the auxiliary storage device 12 with the operation by the operator.

In Act 13, the processor 10 generates a transaction code by combing the transaction number, the payment completion date and time, and the POS terminal code according to a rule that is determined in advance. The processor 10, for example, generates the transaction code by simply listing the transaction number, the payment completion date and time, and the POS terminal code. The rule described above may be arbitrarily determined, for example, by a designer of the POS terminal 1, or the like, but if there is a difference in any one of the transaction number, the payment completion date and time, and the POS terminal code, a different transaction code is set to be generated. Moreover, the transaction code may be generated using other pieces of information, such as the salesperson code that is determined in Act 2. Furthermore, one or several of the transaction number, the payment completion date and time, the POS terminal code, and the salesperson code may not be used. Additionally, if information that is separate from the transaction number, the payment completion date and time, the POS terminal code, and the salesperson code is used, all of the transaction number, the payment completion date and time, the POS terminal code, and the salesperson code may not be used.

In Act 14, the processor 10 generates creation request information for requesting the provision server 3 to create the provision information that will be described below, and transmits the generated creation request information to the provision server 3. Specifically, the processor 10 generates the creation request information in a state where the transaction information that is generated in Act 9, and the transaction code that is generated in Act 13 are included. Then, the processor 10 sends the creation request information, which is destined for the provision server 3, from the communication interface 18 to the communication network 200. Accordingly, the transaction information and the transaction code are notified to the provision server 3. As such, the performance by the processor 10 of the controlling based on the control program enables the computer of which the central portion is the processor 10 to function as a notification unit.

In Act 15, the processor 10 generates printing information for showing contents of the transaction information that is generated in Act 9, and the barcode indicating the transaction code, on the receipt.

In Act 16, the processor 10 performs the printing that is based on the printing information described above, and controls the printer 17 in such a manner that the receipt that is formed as a result of the printing is ejected to the outside of the POS terminal 1. Accordingly, the receipt is issued. The receipt that is issued in this manner shows a name of the purchase commodity, a unit price, purchase points, and the like, and a sum (the payment amount) of prices of the purchase commodity, the deposit money, the change amount, and the like, in the same manner as the receipt that is issued by the ready-made POS terminal. In addition to this, the receipt that is issued as described above shows the barcode representing the transaction code. The receipt is given by the operator to the shopper. As such, the performance by the processor 10 of the controlling based on the control program enables the computer of which the central portion is the processor 10 and the printer 17 to function in cooperation with each other as an issuing unit.

Henceforth, the processor 10 returns to a waiting state in Act 6.

Moreover, although not illustrated, if a job of operating the POS terminal 1 is ended, if the salesperson who operates the POS terminal 1 performs an operation that is determined in advance, the processor 10 returns to the waiting state in Act 1.

Now, the creation request information that is sent from the communication interface 18 by the processing by the processor 10 in Act 14 is transferred by the communication network 200 to the provision server 3. Thus, the communication interface 33 receives the creation request information.

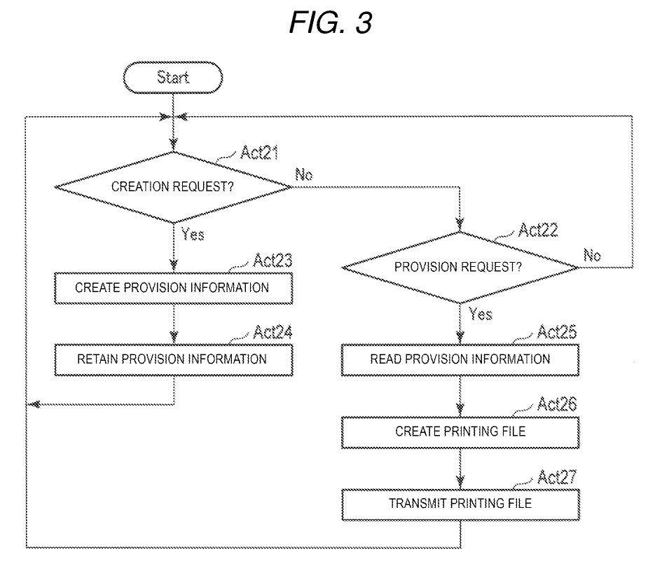

When the provision server 3 is in the normal operation mode, the processor 30 performs the controlling that is based on the control program which is stored in the main memory 31 or the auxiliary storage device 32. FIG. 3 is a flowchart of controlling by the processor 30.

In Act 21, the processor 30 checks whether or not a creation request is made. Then, if the creation request is not made, it is determined that a result is No, proceeding to Act 22 takes place.

In Act 22, the processor 30 checks whether or not a provision request that will be described below is made. Then, if the provision request is not made, the processor 30 determines that a result is No, and returns to Act 21.

As such, in Act 21 and Act 22, the processor 30 waits for the creation request or the provision request to be made. Then, if, as described above, the creation request information is received by the communication interface 33, the processor 30 determines in Act 21 that a result is Yes, and proceeds to Act 23.

In Act 23, along with the transaction information that is included in the creation request information, the processor 30 creates the provision information that has to be provided to the shopper who performs commercial transaction that is indicated by the transaction information. Specifically, the processor 30 analyzes the purchase commodity that is indicated by the transaction information, and creates the provision information as information that has to be provided to the shopper who does shopping in this manner. For example, if a commodity that is associated with a recommended commodity is included in the purchase commodity, the processor 30 creates the provision information that has contents to the effect that it is recommended that a shopper should buy the recommended commodity. Alternatively, if there is deviation in nutrient distribution relating to the purchase commodity, the processor 30 creates the provision information that has contents to the effect that it is recommended that a shopper should buy a commodity suitable for taking in an insufficient nutrient. In a case of these examples, the provision information, for example, is a list of recommended commodities. As such, the performance by the processor 30 of the controlling based on the control program enables the computer of which the central portion is the processor 30 to function as a creation unit that creates the provision information.

Which analysis to be performed, which algorithm to be used, and which provision information to be created may be arbitrary, and for example, may be suitably determined by a designer of the provision server 3, a creator of the control program, an administrator of the provision server 3, an administrator of the POS terminal 1, or the like. Furthermore, if a plurality of POS terminals 1 that are installed in a plurality of shops, respectively, are included in the information provision system 100, a method of creating the provision information may be determined for every store.

In Act 24, the processor 30 retains the created provision information, which is described above, in the main memory 31 or the auxiliary storage device 32, in a state of being associated with the transaction code that is included in the creation request information. As such, the main memory 31 or the auxiliary storage device 32 functions as a storage unit in which the provision information or the transaction code is stored in a state of being associated with each other.

Then, henceforth, the processor 30 returns to the waiting state in Act 21 and Act 22.

In this manner, whenever payment relating to one commercial transaction is completed in the POS terminal 1, in the provision server 3, the provision information is created with contents of the commercial transaction in mind, and is retained in a state of being associated with the transaction code for identifying the commercial transaction.

If the shopper wants to be provided with the provision information relating to the shopping that is done at this time, the shopper moves to a place where the information terminal 2, carrying the received receipt, and causes the barcode that is printed on the receipt, to be read by the barcode reader 25 of the information terminal 2. Thus, the barcode reader 25 optically reads the barcode, and outputs barcode information that is indicated by the barcode. As such, the barcode reader 25 is equivalent to a reading unit that optically reads the barcode that is a visible code which is printed on the receipt.

When the information terminal 2 is in the normal operation mode, the processor 20 performs the controlling that is based on the control program which is stored in the main memory 21 or the auxiliary storage device 22.

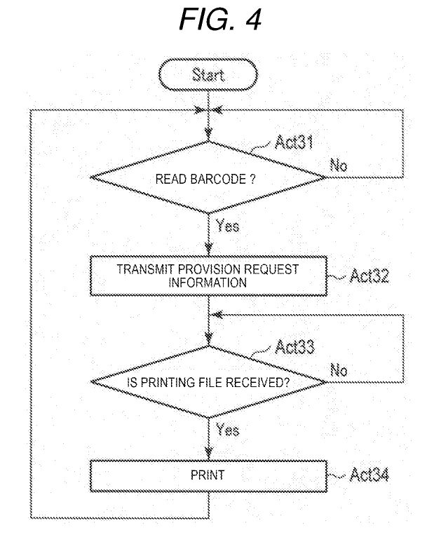

FIG. 4 is a flowchart of controlling by the processor 20.

In Act 31, the processor 20 checks whether or not a barcode is read by the barcode reader 25. Then, if the barcode is not read, the processor 20 repeats Act 31. As such, in Act 31, the processor 20 waits from the barcode to be read. Then, if the barcode is read in the barcode reader 25 as described above, the processor 20 determines that a result is Yes, and proceeds to Act 32.

In Act 32, the processor 20 generates provision request information for requesting the provision server 3 to provide the provision information, and transmits the generated provision request information to the provision server 3. The processor 20 generates the provision request information that includes the transaction code which is extracted by decoding the barcode data that is output from the barcode reader 25, as described above. Then, the processor 20 sends the provision request information, which is destined for the provision server 3, from the communication interface 27 to the communication network 200. As such, the performance by the processor 20 of the controlling based on the control program enables the computer of which the central portion is the processor 20 to function as a request unit that makes a request to the provision server 3 for information provision.

The provision request information is transferred by the communication network 200 to the provision server 3. Thus, the communication interface 33 receives the provision request information. In response to this, the processor 30 determines in Act 22 in FIG. 3 that a result is Yes, and proceeds to Act 25.

In Act 25, the processor 30 reads the provision information of which the provision is requested by the received provision request information, which is described above. Specifically, the processor 30 reads the provision information that is retained in a state of being associated with the transaction code which is included in the provision request information, from the main memory 31 or the auxiliary storage device 32.

In Act 26, the processor 30 generates the printing file for printing information, which is indicated by the provision information that is read, in the information terminal 2. The printing file may in any format, but, for example, is assumed to be set to be in the portable document format (PDF).

In Act 27, the processor 30 sends the printing file described above, which is destined for the information terminal 2 that transmits the provision request information, from the communication interface 27 to the communication network 200.

At this point, this is equivalent to the provision information being transmitted as the printing file, because the printing file is a data file for printing contents of the provision information. Therefore, the performance by the processor 30 of the controlling based on the control program enables the computer of which the central portion is the processor 30 and the communication interface 27 to function in cooperation with each other as a transmission unit that transmits the provision information.

Then, henceforth, the processor 30 returns to the waiting state in Act 21 and Act 22.

The printing file is transferred by the communication network 200 to the information terminal 2. Thus, the communication interface 27 receives the printing file.

Now, after transmitting the provision request information in Act 32 in FIG. 4, the processor 20 in the information terminal 2 proceeds to Act 33.

In Act 33, the processor 20 checks whether or not the printing file is received. Then, because the printing file is not received, if it is determined that a result is No, the processor 20 repeats Act 33. As such, in Act 33, the processor 20 waits for the printing file to be received. Then, when the printing file is received by the communication interface 27 as described above, the processor 20 determines that a result is Yes, and proceeds to Act 34.

In Act 34, the processor 20 performs the printing that is based on the printing file described above, and controls the printer 26 in such a manner that a guide that is formed as a result of the printing is ejected to the outside of the information terminal 2. Accordingly, the guide is issued in which the provision information is shown. As such, the provision information is output in such a manner that the provision information is visible in the form of the guide to a shopper that is an operator of the information terminal 2. More precisely, the performance by the processor 20 of the controlling based on the control program enables the computer of which the central portion is the processor 20 and the printer 26 to function in cooperation with each other as an output unit.

Then, henceforth, the processor 20 returns to the waiting state in Act 31.

With the information provision system 100 as described above, the guide showing the provision information in accordance with the contents of the commercial transaction that is performed by the shopper can be caused to be acquired by the shopper. More precisely, with the information provision system 100, the provision information can be provided to the shopper. Then, in the information provision system 100, because, without identifying the shopper, the provision information in accordance with the contents of one commercial transaction is provided, the information can be provided to an unspecified shopper that is not registered as a member.

Besides, with the information provision system 100, because the issuing of the guide is performed in the information terminal 2 that is separate from the POS terminal 1 which performs the paying, after the paying is ended in the POS terminal 1, processing relating to the next commercial transaction can be started without waiting from the issuing of the guide to be ended. Accordingly, the issuing of the guide does not decrease the efficiency of the paying in the POS terminal 1.

Furthermore, with the information provision system 100, the issuing of the guide is not performed until the shopper that carries the receipt which is issued in the POS terminal 1 moves to the place where the information terminal 2 is installed, and then the shopper causes the barcode to be read by the barcode reader 25. For this reason, with the information provision system 100, the time that it takes to print the provision information after ending the paying is lengthened compared with a case where the provision information is printed on the receipt in the POS terminal 1, or a case where a guide is issued separately from the receipt in the POS terminal 1. For this reason, it is possible that a certain amount of time is consumed in processing of the contents of the commercial transaction.

According to the embodiment, various modification examples are possible as follows.

Instead of issuing the guide showing the provision information, the provision information may be output, for example, using a method other than the printing, such as displaying on the display device 24 or outputting as an audio message, or the like.

Instead of the POS terminal 1, the information provision system 100 may include an apparatus for payment that is not equipped with a function of performing the registering, or a function of performing certain registering and calculating.

The POS terminal 1 may issue a voucher showing the barcode representing the transaction code, separately from the receipt.

The information terminal 2 may be carried by the shopper, without being installed in the store. For example, instead of the information terminal 2, a smartphone can be used. However, if the smartphone is used, instead of issuing the guide through the printing, displaying on a display can be suitable. However, the guide can be printed using a printer that is connected to the smartphone.

Types of processing, such as the analysis of the purchase commodity, the creation of the provision information, the generation of the printing file, and the like, that are performed by the provision server 3 according to the embodiment may be performed by a plurality of servers in a distributed manner.

In the provision server 3, instead of retaining the provision information in the main memory 31 or the auxiliary storage device 32, the printing file may be retained in the main memory 31 or the auxiliary storage device 32.

The provision information, as is, may be transmitted from the provision server 3 to the information terminal 2. Then, in this case, the information terminal 2 is set to generate the printing file based on the provision information, and to perform the printing that is based on the printing file, in the printer 26.

If a condition that is established in advance is satisfied, the processor 30 in the provision server 3 may delete the provision information that is retained in the main memory 31 or the auxiliary storage device 32. In this case, the computer of which the central portion is the processor 30 functions as a deletion unit. The condition is arbitrary, but, for example, if the transmission of the printing file that is generated based on the provision information, a case where a period of time for which the provision information is retained exceeds a given period of time, or the like is taken into account. Moreover, if the provision information is deleted in this manner, the processor 30 of the provision server 3 cannot read the provision information in Act 25. Accordingly, in such a case, instead of the printing file, the processor 30 transmits error information. Then, the processor 20 of the information terminal 2 that receives the error information displays a message to the effect that there is no information that has to be provided, on the display device 24. In this case, the computer of which the central portion is the processor 20 and the display device 24 is enabled to function in cooperation with each other as an informing unit. Alternatively, in Act 26, the processor 30 may generate the printing file showing a message to the effect that there is no information which has to be provided. In this case, the performance by the printer 26 of the printing that is based on the printing file under the control of the processor 20 enables the computer of which the central portion is the processor 20 and the printer 26 to function in cooperation with each other as the informing unit.

According the embodiment, an act of buying and selling a commodity is described as the commercial transaction, but the commercial transaction may not be accompanied by the act of buying and selling the commodity. For example, a check-out system according to an exemplary embodiment can also apply to a transaction in which a charge for providing a service (labor), such as a rental fee for a rental product, occurs. More precisely, the “commodity” is not limited to goods, and may be a service. Therefore, the “purchase commodity” includes a service that is provided from a provider to a beneficiary for a fee.

It is also possible that one or several portions of or all portions of the function that is realized by the controlling by each of the processor 10, 20, and 30 are realized by hardware that performs information processing which is not based on any program, such as a logic circuit. Furthermore, it is also possible that each of the functions is realized by combining the hardware, such as the logic circuit, with software control.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information provision system comprising:
a payment terminal;
an information provision apparatus; and
an information terminal,
wherein the payment terminal includes
a payment unit configured to make a payment of a price relating to a commercial transaction,
a notification unit configured to notify the information provision apparatus of transaction information indicating contents of the commercial transaction and a transaction code for identifying the commercial transaction, after the payment is completed by the payment unit, and
an issuing unit configured to issue a voucher on which a visible code that represents the transaction code in an optically readable manner is printed,
wherein the information provision apparatus includes
a creation unit configured to create provision information that is provided to a person who makes a payment for the commercial transaction relating to the transaction information, based on the transaction information that is notified by the notification unit, and
a storage unit configured to store the provision information that is created by the creation unit, in a state of being associated with the transaction code that is notified along with the transaction information, based on which the provision information is created,
wherein the information terminal includes
a reading unit configured to optically read the visible code that is printed on the voucher, and
a request unit configured to make a request to the information provision apparatus for information provision, which is accompanied by the notification of the transaction code that is represented by the visible code which is read by the reading unit,
wherein the information provision apparatus further includes
a transmission unit configured to transmit to the information terminal the provision information which is stored in the storage unit in the state of being associated with the transaction code that is notified when the request is made by the request unit, and
wherein the information terminal further includes
an output unit configured to output the provision information which is transmitted by the transmission unit, in a such a manner that the provision information is recognizable to an operator of the information terminal.

2. The system according to claim 1,
wherein the output unit prints contents of the provision information in such a manner that the contents are visually observable to the operator.

3. The system according to claim 1,
wherein the information provision apparatus further includes
a deletion unit configured to delete the provision information that satisfies a condition which is determined in advance, from the storage unit.

4. The system according to claim 3,
wherein the information terminal further includes
an informing unit configured to inform the operator that the provision information is not stored, if the provision information is not stored in the storage unit, in the state of being associated with the transaction code that is represented by the visible code which is read by the reading unit.

5. An information provision method that is performed by a payment terminal, an information provision apparatus, and an information terminal,
wherein the payment terminal
makes a payment of a price relating to a commercial transaction,
notifies the information provision apparatus of transaction information indicating contents of the commercial transaction and a transaction code for identifying the commercial transaction, after the payment is completed, and
issues a voucher on which a visible code that represents the transaction code in an optically readable manner is printed,
wherein the information provision apparatus
creates provision information that is provided to a person who makes a payment for the commercial transaction relating to the transaction information, based on the transaction information that is notified, and
stores the provision information that is created, in a state of being associated with the transaction code that is notified along with the transaction information, based on which the provision information is created,
wherein the information terminal
optically reads the visible code that is printed on the voucher, and
makes a request to the information provision apparatus for information provision, which is accompanied by the notification of the transaction code that is represented by the visible code which is read,
wherein the information provision apparatus further
transmits to the information terminal the provision information which is stored in the state of being associated with the transaction code that is notified when the request is made, and
wherein the information terminal further
outputs the provision information which is transmitted, in a such a manner that the provision information is recognizable to an operator of the information terminal.
